(19) United States
(12) Patent Application Publication
(10) Pub. No.: US 2016/0122440 A1
(43) Pub. Date: May 5, 2016

(54) MODIFIED WOOD FIBRES FOR MANUFACTURE IN COMPOSITES

(71) Applicant: CC Wood B.V., Bussum (NL)

(72) Inventor: Arie C. BESEMER, The Hague (NL)

(21) Appl. No.: 14/895,554

(22) PCT Filed: Jun. 3, 2014
(86) PCT No.: PCT/IB2014/061910

§ 371 Date: Dec. 3, 2015

(30) Foreign Application Priority Data
Jun. 3, 2013 (ZA) 2013/04029

(51) Int. Cl. C08B 3/06

(52) U.S. Cl. CPC C08B 3/06

(57) ABSTRACT

A method for the acylation of lignocellulose by exposing the lignocellulose to an acylation agent in a closed vessel.

### TECHNICAL FIELD OF THE INVENTION

Wood fibres, like sawdust, can be processed in combination with plastic materials e.g. poly-propylene to obtain composite materials. The main advantage of this process is that a green and renewable material can be used that is cheaper and lighter than polypropylene or other oil-based polymers. However, the objects manufactured from these materials exhibit short-comings, especially with respect to their strength properties and to their limited useful life, owing to the hydrophilic and hygroscopic character of the wood fraction. Because methods to improve the properties are relatively expensive, there is a need for a cheap and simple method to modify the wood fibres to make them more compatible with highly hydrophobic polymers and less vulnerable to microbial decay, light, dawn-frost and humid weather conditions.

### SUMMARY OF THE INVENTION

The general composition, structure and properties of wood are described in the book “Wood Chemistry Fundamentals and Applications” (Eero Sjöström, AP, 2^{nd} Edition, 1993). Wood appears to have a complex chemical and mechanical structure. It consists mainly of polysaccharides and lignin, which are closely connected both in chemical and physical sense.

The hydrophil property of wood and more in particular, sawdust is to be ascribed to the cellulose and hemicellulose part. It has been shown that the hygroscopic character of wood and other lignocellulosic materials can be diminished by chemical modification with suitable reagents. Numerous articles, patents and surveys have been published about the modification of wood and other lignocellulosic materials in order to improve their quality with respect to dimensional stability.

The manufacture of composites consisting of fossil-based polymers and wood-based biopolymers (commonly called WPC) has growing interest. However, it has been recognised that the materials have shortcomings, especially with respect to mechanical properties, proneness to biological decay, humidity and UV-light. Under normal conditions cellulose always contains a substantial amount of water, which may vary between 5-20%, dependent on the relative humidity of the ambient air. To diminish the hydrophilic and hygroscopic character of cellulose and hemicellulose in wood, one may modify the material by reaction with a hydrophobic material with chemical agents such as acid anhydrides, isocyanates and epoxides.

Also the use of polymaleic acid anhydride as a reactive additive is mentioned. A survey of chemical modifications is given by Rowell. (R. M. Rowell, review article in Forest Products Abstracts, 6 (1983) 363-382). Rowell mentions amongst others acid anhydrides, aldehydes, isocyanates and epoxides. It is apparent that many modifications of wood can be applied to other lignocellulosic materials as well. It is apparent that, from the many agents investigated and discussed, the best agent is acetic anhydride. Acetic anhydride reacts with the alcohol groups of cellulose and hemicellusose, giving esters. Esterification of an alcohol can be accomplished by various methods, as described in the text books Organic Chemistry.

The basic method consists of reacting a carboxylic acid with an alcohol in the presence of a strong acid. This reaction is an equilibrium in which beside the ester, water is formed. Usually it takes a long reaction time (hours) and high temperature. Moreover, the presence of a strong acid catalyst, such as sulphuric acid or p-toluene sulphonic acid is required. However, it appears to be impossible to complete the reaction unless one of the reaction components (water or ester) is removed to shift the equilibrium. To overcome the drawbacks connected to the classical method, alternatives have been found. Reactions with anhydrides or acid chlorides proceed faster and are quantitative. The first conversion of lignocellulosic material was indeed carried out with liquid acetic anhydride (Fuchs, Berichte der Deutschen Chemischen Gesellschaft, 61B, 948 (1928)).

WO 2010089604 describes acetylation of lignocellulosic material through treatment with acetic anhydride and an aqueous organic based formulation which comprises an organic material with a high molecular weight polymeric based material including that of a condensation polymer or an amide, an amine, an ester, aldehyde, ketone, anhydride or an alkyd based material. The method is aimed at providing a hardened lignocellulosic material product. U.S. Pat. No. 7,790,239 describes the use of mixed anhydrides. It is shown that the esterification of wood sawdust in the presence of a strong acid catalyst makes it possible to confer a hydrophobic nature on this sawdust. Patent GB 2399818 describes a method of acetylating a lignocellulose material, which uses radio frequency radiation as a way of providing heat. Acetic anhydride is preferably used as an acetylating agent.

In a related series of patents (U.S. Pat. No. 5,821,359, EP 0650998 and EP 0746570) inventions are described, which relate to a process for acetylation of lignocellulosic fibres using an acetylating agent comprising acetic anhydride it is described that exposure of lignocellulosic material to acetic anhydride can be conducted at 80-140° C., but that the material afterwards is treated with superheated acetic acid and/or acetic anhydride at high temperature (140-180° C.), with the aim of removing unreacted acetic anhydride and the by-product acetic acid. It is claimed that after treatment with e.g. acetic anhydride at this high temperature the material is substantially free from occluded, adsorbed or absorbed acetylating agent. EP 0680810 describes the use of acetic anhydride and a method to remove adhering acetic anhydride and acetic acid by applying a vacuum. WO 9409057 describes a process in which the reaction of lignocellulosic material with acetic anhydride vapour greatly improves dimensional stability and resistance to biological attack and is according to this invention made in the absence of any co-solvent or added catalyst in a simple way, very speedily with optimisation of raw material feed and without the need for distillation/rectification. U.S. Pat. No. 4,804,384 (A) describes the reaction of lignocellulosic material with uncatalyzed acetic anhydride in the absence of any co-solvent. The process improves dimensional stability and resistance to biological attack of the lignocellulosic material. Lignocellulosic material is treated by exposure to liquid acetic anhydride for at least a short period of time, after which it is then heated to acetylate the material. The excess anhydride and by-product acetic acid can be removed by vacuum. Acetic acid can be recovered by reaction with ketene.

The processes as described above have the disadvantage that only one acetic moiety is used and that the other acetyl group has to be removed as acetic acid. It is generally stated that acetic acid as a result of acetylation is a by-product, which is either lost or trapped in order to be recovered

### DESCRIPTION OF THE INVENTION

This patent specification discloses a procedure in which an anhydride is used and the released carboxylic acid group is further reacted, giving a better yield of the reagent and/or a better product i.e. more hydrophobic. It has been found that this can be achieved by applying a higher temperature and a longer reaction time with a pre-requisite that the modification is carried out in a closed vessel.

The invention described herein provides for a method for the acylation of lignocellulose by exposing the lignocelluloses to an acylating agent present in the gas phase at a temperature in the range of 120° C. to 190° C.

There is further provided for the by-product acetic acid to react at high temperature in a closed vessel.

It has been established that under these conditions more than one acetyl group per molecule acetic anhydride is introduced. A suitable method is to expose sawdust in a layer of a few cm thickness in a closed compartment, in which in a separate vessel acetic anhydride is present. The current invention is based on the fact that acetic acid is also able to react. At high temperature (i.e. 140-190° C.) the efficiency of the reaction exceeds 100%, suggesting that per molecule acetic anhydride more than one acetyl group is introduced and that acetic acid formed, has reacted as well.

As follows from literature an important effect of acetylation is the diminished hygroscopic character of the treated material. This fact has been used in this disclosure to prove that the reaction is effective. Moreover, WPC-objects were made and their strength properties were determined. From the experiments, it can be concluded that the water uptake is greatly diminished and that the strength properties are significantly increased.

Another advantage of the procedure according to this invention is that the biological resistance against fungi is improved. Even with a relatively low degree of acetylation, the products proved to be completely resistant against white and brown rot (fungi).

According to the procedure, described for acetic anhydride other anhydrides can be used such as propionic anhydride, butyric anhydride and cyclic anhydrides such as maleic anhydride, succinic anhydride, glutaric anhydride and o-phthalic anhydride. When cyclic anhydrides are used, one should account for the fact that the carboxylic acid group may react to give different effects i.e. intramolecular and intermolecular reactions may occur. In the first case the reaction may proceed intra-residue or inter-residue, whereas in the second case the result will be cross-linking of adjacent polymer chains. Cross-linking may be beneficial because of the enhanced polymer-polymer interaction that will occur, with as a consequence a diminished water uptake. Moreover, it is obvious that according to the invention two or more anhydrides may be applied simultaneously.

The wood fibres processed as described in this document can be applied in a variety of composite materials that are used in automotive industry, wood furniture, and building materials.

### EXAMPLES

### 1. Treatment of Wood Fiber with Acetic Anhydride

In a closed vessel, sawdust (softwood) was exposed to acetic anhydride (Aldrich). The temperature was gradually increased from room temperature to 100° C. After standing for 15 minutes, the temperature was further increased to 140° C. In the experiments 1 and 2 the exposure time was 30 minutes; in the experiments 3 and 4 the time was two hours. In order to remove unreacted acetic anhydride and acetic acid, the sawdust was heated in open air during 15 minutes at 130° C. After cooling the weight gain was measured. The results are summarised in Table 1.

If one takes into account that one molecule acetic anhydride results in the introduction of one acetyl group the use of 1 mmol acetic anhydride results in a weight gain of 42 mg (assuming excess of the substrate). However, when acetic acid also reacts, the weight gain will be 84 mg. As can be seen from Table 1 the weight gain is higher when the temperature is raised and the exposure time is elongated. The yield in the latter experiments (3 and 4) is 140%. The humid uptake was approximately 8%, being less than that of the control (11.5%).

TABLE 1
Acetylation of sawdust with acetic anhydride

| | Weight | Acetic | | | Uptake | Uptake |
|---|---|---|---|---|---|---|
| | (grams oven | anhydride | Weight | Yield¹ | water | water |
| Entry | dry 130° C.) | (mg) | gain (mg) | (%) | (mg) | (%)² |
| 1a | 3,3290 | 200 | 60 | 73 | 327 | 8.2 |
| 1b | 3,9731 | 200 | 63 | 77 | 288 | 8.0 |
| 2a | 1,1353 | 140 | 42 | 42 | 93 | 8.2 |
| 2b | 1,1649 | 140 | 44 | 76 | 94 | 8.0 |
| 3a | 3,1603 | 140 | 90 | 156 | 236 | 7.5 |
| 3b | 2,0426 | 140 | 75 | 130 | 160 | 7.8 |
| 4a | 5,1432 | 140 | 90 | 156 | 440 | 8.5 |
| 4b | 3,2133 | 140 | 71 | 123 | 270 | 8.4 |

¹Yield calculation based upon introduction of one acetyl group per molecule acetic anhydride
²Water uptake of control is 11.5%

### Example 2

### Wood Plastic Composite-Properties

3 kg sawdust was exposed to 300 g acetic anhydride (Aldrich) in a closed vessel, initially at 100° C. during 30 minutes. After this period, the temperature was gradually increased to 130° C. and the material was exposed during 60 minutes. At last, the material was heated open to air to remove acetic acid and acetic anhydride

From this material test samples WPC-samples were manufactured and its strength properties measured and compared to those of a blank (untreated) sample.

Manufacture of the WPC-samples and determination of their properties were carried out by prof. Bledzki and co-workers at the University of Kassel, Institut für Werkstofftechnik. Kunststoff-und Recyclingtechnik (Mönchebergstraβe 3 34125 Kassel)

TABLE 2
Strength properties of WPC-objects manufactured from acetylated sawdust

| | Tensile | Flexural | Tensile | Flexural | Charpy |
|---|---|---|---|---|---|
| | modulus | modulus | strength | strength | index |
| sample | (MPa) | (MPa) | (MPa) | (MPa) | mJ/mm2 |
| blank | 3,200 | 3,300 | 24 | 30 | 4.2 |
| Acetylated wood | 4,900 | 5,500 | 33 | 54 | 4.7 |

### Example 3

### Alternative Acetylation Method

To 17 g sawdust (softwood) 870 mg acetic anhydride (Aldrich) was added and this composition was immediately mixed in a blender. A sample of this mixture (1-3 grams) was heated in a closed vessel. The temperature was gradually increased from 20 to 100° C. and maintained for 15 minutes. Then the temperature was further raised to 140° C. and kept during 30 minutes. Finally the sawdust was heated at 170° C. during 15 minutes. The vessel was then opened and the modified sawdust was heated at 130° C. to remove water, acetic acid and unreacted acetic anhydride. The sample was exposed to air (relative humidity approximately 50%) and the uptake of water from the ambient air was determined and compared to that of an untreated sample sawdust.

In this series of experiments also the effect of longer standing of the sample in the presence of acetic anhydride at room temperature was investigated before heating took place. Diffusion of acetic anhydride into the inner part is a slow process. The results are summarised in Table 3.

TABLE 3
Acetylation of sawdust with acetic anhydride,
distributed homogeneously through the reaction mixture

| | Reaction time at | | | |
|---|---|---|---|---|
| | room temperature | | Water uptake | Water uptake |
| Entry | (days) | Weight (g) | (mg) | (%) |
| Blank¹ | — | 1.2650 | 151.0 | 11.9 |
| Blank² | 4 | 1.3889 | 114.8 | 8.3 |
| 1 | 0 | 2.5760 | 228.0 | 8.7 |
| 2 | 3 | 2.8649 | 204.9 | 7.2 |
| 3 | 4 | 2.8760 | 199.8 | 6.9 |

¹Untreated sample
²This sample was not heat-treated, but was allowed to react at 19-21° C. during 4 days.

It is clear that by allowing diffusion to take place into the deeper zones of the wood particles (comparable to soaking in the liquid phase), the water uptake of the final product diminishes.

From the experiments 1-3 it can be concluded that heat treatment at>140° C. and longer reaction times leads to further decrease in water uptake. Moreover, it has been established that measures to expose the lignocellulosic material to gaseous acetic anhydride can be replaced by simply mixing the material with the reagent and heating it in a closed vessel.

### Example 4

### Test Materials

25 specimens WPC: PP 40%+acetylated sawdust of softwood 60%, prepared by University Kassel, Institut für Werkstofftechnik, Kunststoff-und Recyclingtechnik (Mönchebergstraβe 3 34125 Kassel).

Preparation of the Specimens

The specimens were sawn into 50 test specimens of 25 mm length and 20 mm width. During 14 days the specimens, separated from each other by stainless steel grids, were submerged in demineralised water at a temperature of 70° C. in a closed glass container (Defoirdt N., Gardin S. Van der Bulcke J. and Van Acker J. Moisture dynamics of WPC and the impact of fungal testing, International Biodeterioration and Biodegradation 64(1):p 65-72, 2009). The saturated specimens were sterilized by means of gamma irradiation at Sterigenics n.v.

Procedure

The fungal test was executed according to EN 12038. 20 test specimens were exposed to white rot, 20 test specimens were exposed to brown rot during 16 weeks. The following test fungi were used:

White rot: Poria placenta (Fries) Cooke sensu J. Eriksson (strain: FPRL 280)

Brown rot: Coniophora puteana (Schumacher ex Fries) Karsten (strain: BAM Ebw.15)

Scots pine sapwood is used as reference timber to control the virulence of the test fungi.

Results

A summary of the mean and median mass losses of the materials after 16 weeks exposure per test fungus is given in the table below.

TABLE 4
Mass loss of WPC samples after exposure to white and
brown rot fungi during 16 weeks.

| | | | Mean | Median |
|---|---|---|---|---|
| | | Median | mass loss | mass loss |
| | Mean | mass loss | (%) | (%) |
| | mass loss (%) | (%) | Reference | Reference |
| | WPC | WPC | timber | timber |
| White rot | 0.0 | 0.0 | 42.3 | 43.3 |
| (Poria placenta) | | | | |
| Brown rot | 0.0 | 0.0 | 28.1 | 27.6 |
| (Coniophora | | | | |
| puteana) | | | | |

Because of the fact that the decay of the reference specimens, exceeds 20%, the test results are valid. Although no mass loss was observed, the test specimens showed some discoloration. Specimens exposed to white rot were paler, whereas those exposed to brown rot were darker. It is to be concluded that the WPC-material prepared according to the invention has a very good resistance against attack by brown and white rot. Therefore the material is given a provisional rating against wood destroying basidiomycete fungi of 1, which means very durable, mean loss≦5%, according to the rating scale described in EN 15083-11:2004/Annex D). The absence of decay is attributed to the resistance of the material and not to a too low moisture content of the material as the moisture content of the wooden particles of the WPC-material(mc_{wood}) exceeds the minimum threshold for fungal growth (≧20%).

1. A method for the acylation of lignocellulose by exposing the lignocellulose to an acylation agent in a dosed vessel.

2. A method as claimed in claim 1 wherein more than one acyl group per molecule of acylation agent is introduced.

3. A method as claimed in claim 1 wherein the acylation agent is present in the gas phase and is carried out at a temperature in the range of 12Q° C. to 19QX.

4. A method as claimed in claim 1 wherein an anhydride is used as the acylation agent.

5. A method as claimed in either claim 3 wherein the anhydride is chosen from any one or more of the group including acetic anhydride; propionic anhydride; butyric anhydride and cyclic anhydrides such as maieic anhydride, succinic anhydride, glutaric anhydride and ophthalic anhydride,

6. A method as claimed in claim 1 wherein in more than one anhydride may be utilised simultaneously.

7. A method as claimed in claim 3 wherein a carboxylic acid is released and is further reacted with the lignocellulose.

8. A method as claimed in claim 7 wherein the carboxylic acid is acetic acid.

9. A method as claimed in claim 1 comprising the following steps:
adding a layer of a few cm thickness of sawdust into a closed vessel; and
exposing the sawdust to a gaseous acylation agent at a temperature of between 140° C.-190X.
